(19) United States
(12) Patent Application Publication
(10) Pub. No.: US 2025/0029474 A1
(43) Pub. Date: Jan. 23, 2025

(54) 911 LOCATION ACCURACY TESTING

(71) Applicant: DISH Wireless L.L.C., Littleton, CO (US)

(72) Inventors: William Beckwith, Washington, DC (US); Darci O’Hearn, Littleton, CO (US); Mehdi Alasti, Arlington, VA (US)

(21) Appl. No.: 18/353,291

(22) Filed: Jul. 17, 2023

(51) Int. Cl. G08B 25/00; H04W 64/00

(52) U.S. Cl. CPC G08B 25/003; H04W 64/003

(57) ABSTRACT

Systems and methods for facilitating inter-network handover of a communication with a call center are provided. In one example, a computer-implemented method includes: receiving, at a first network from a second network, information indicating a location of a user device, detecting, at the first network, presence or absence of an active connection between the user device and a call center designated to the first network, obtaining, at the first network, the location of the user device from the received information, in response to the detection of the presence of the active connection, and transmitting the information indicating the location to a location database in communication to the call center.

### BACKGROUND

The ability to access emergency response services by dialing a reserved emergency telephone number, such as 911 in the United States, is a vital component of public safety and emergency preparedness. In the United States, the Federal Communications Commission (FCC) has established a set of rules and regulations that require mobile communication providers to deliver enhanced emergency services to their subscribers. In particular, mobile communication providers are required to provide a current location of a 911 caller to emergency services.

Specifications defined by the 3rd Generation Partnership Project (3GPP) for support of emergency calls enable a user equipment (UE) to originate an emergency call using a 3GPP defined wireless access type with connectivity to a 3GPP core network, where the emergency call is routed by a 3GPP core network to a Public Safety Answering Point (PSAP) whose service coverage area includes the location of the calling UE. 3GPP specifications also support certain types of handover of an emergency call that may need to occur when an emergency call moves to a new location and no longer has wireless coverage from a previous serving network. However, handover of an emergency call may have limitations and may generate problems for timely and accurately reporting the location information to the PSAP.

### SUMMARY

In accordance with some embodiments of the present disclosure, a method for facilitating inter-network handover of a communication with a call center is provided. The method may be implemented by at least one electronic processor configured to execute computer programs. The method may include: receiving, at a first network from a second network, information indicating a location of a user device, detecting, at the first network, presence or absence of an active connection between the user device and the first network, obtaining, at the first network, the location of the user device from the received information, in response to the presence of the active connection, and transmitting the information indicating the location to a location database in communication to the call center. The method may further include: obtaining, at the first network, last-known location of the user device, and comparing, at the first network, the location of the user device received from the second network with the last-known location of the user device. The transmission of the location of the user device to the call center is performed after an outcome of the comparison indicates a difference between the location of the user device and the last-known location of the user device.

In accordance with some embodiments of the present disclosure, a system is provided. In one example, the system includes: one or more processors and a computer-readable storage media storing computer-executable instructions. The computer-executable instructions, when executed by the one or more processors, cause the system to: receive, at a first network from a second network, information indicating a location of a user device, detect, at the first network, presence or absence of an active connection between the user device and the first network, obtain, at the first network, the location of the user device from the received information, in response to the presence of the active connection, and transmit the information indicating the location to a location database in communication to the call center. The computer-executable instructions, when executed by the one or more processors, may further cause the system to obtain, at the first network, last-known location of the user device, and compare, at the first network, the location of the user device received from the second network with the last-known location of the user device.

In accordance with some embodiments, the present disclosure also provides a non-transitory machine-readable storage medium encoded with instructions, the instructions executable to cause one or more electronic processors of a system to: receive, at a first network from a second network, information indicating a location of a user device, detect, at the first network, presence or absence of an active connection between the user device and the first network, obtain, at the first network, the location of the user device from the received information, in response to the presence of the active connection, and transmit the information indicating the location to a location database in communication to the call center. The computer-executable instructions, when executed by the one or more electronic processors of the system, may further cause the system to obtain, at the first network, last-known location of the user device, and compare, at the first network, the location of the user device received from the second network with the last-known location of the user device.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a schematic block diagram illustrating a communication system for communicating the location information regarding a user device to a call center, according to various embodiments.

FIG. 2 is a schematic block diagram illustrating a communication system for communicating location information regarding a user device that is roaming out of a home network to a call center, according to various embodiments.

FIG. 3 is a flow diagram illustrating an example method for facilitating a communication with a call center, according to various embodiments.

FIG. 4 is a flow diagram illustrating an example method for facilitating inter-network handover of a communication with a call center, according to various embodiments.

FIG. 5 is a flow diagram illustrating an example method for facilitating inter-network handover of a communication with a call center, according to various embodiments.

FIG. 6 is a block diagram illustrating an example of a hardware implementation of an example user device, according to various embodiments.

FIG. 7 is a schematic diagram illustrating an example of computer system or computer device, according to various embodiments.

### DETAILED DESCRIPTION

### Overview

In various embodiments, technical solutions are provided to facilitate communication handover from a first network to a second network without disconnecting the communication. In some embodiments, after a user initiates an emergency call on a user device (UD) in a home network and connects to a call center, the user roams out of the home network (i.e., a first network) and into a visited network (i.e., a second network or an away network). The first and the second network may be both a public land mobile network (PLMN). The away network is sometimes also referred to as a “visited network,” and the “away network” and the “visited network” are used interchangeably in the disclosure. In this scenario, in accordance with the present disclosure, the emergency call with the call center is handed over to the away network. This is known as inter-PLMN handover. It is desired that the connected emergency call with the call center is not dropped, but rather transferred to the away network so that the same call center is helping the caller (i.e., the user of the UD) even when the user's UD roams out of the home network. It should be understood, although various embodiments are described herein in the context of emergency call handover, this is not intended to limit the present disclosure only to emergency call handover across communications networks. It should be understood that various technical solutions provided herein can be applied to non-emergency call handover.

Typically, during an emergency call, location information about one or more callers need be readily available to an operator (e.g., a person answering the emergency call at the call center such as PSAP) handling the emergency call. For example, location databases are used to store up-to-date location information about the callers and/or the UD, and the location databases are accessible to operators of call centers that handle the emergency calls. With the location information, a given operator can dispatch help to the caller in response to the emergency call.

However, one insight provided by the present disclosure is that there lies a challenge to transfer location information regarding the UD to the away network in the inter-network emergency call handover. That is, if the UD is a control panel (CP) location-based device, such as Apple iPhone, the control plane connectivity is lost after the user device moves out of the home network. This is mainly because the CP location-based UD provides its location information through a control plane connection with the home network, and once the UD leaves the home network, that connection is lost. Even after the handover to the away network is executed for the emergency call in that scenario, the control plane connection with the CP location-based UD is not established. Thus, in that scenario, the location information is lost for the CP location-based UD after it leaves the home network, which, as described above, is not compatible with the call centers that handle emergency calls.

As mentioned, in various embodiments, the present disclosure provides techniques for solving the above-mentioned challenges. One insight of the present disclosure is that when roaming out of the home network, during an active emergency call, the CP location-based UD can be configured to send their location information on their own. In various embodiments, the home network can be configured to obtain the location information sent by the roaming CP location-based UDs and transfer that information to a storage (i.e., a location database) connected to a call center handling the emergency call.

One insight provided by techniques provided herein includes configuring a CP location-based UD such that it can send its current location information through a Session Initiation Protocol (SIP) packet, e.g., a SIP header or SIP OPTIONS or SIP UPDATE. The SIP packet can be routed back to the home network through the user plane, which can be detected at the home network. At that point, the current location of the UD can be extracted from the SIP packet and transmit to the call center.

Another insight provided by techniques provided herein includes configuring the home network to compare the last known (to the home network) user device location with the user device location from the away network, and transfer the user device location to a database of the call center only when there is an update in the user location device. In this way, flooding the database with the same location information received from the away network could be effectively prevented.

### Example Systems and Devices

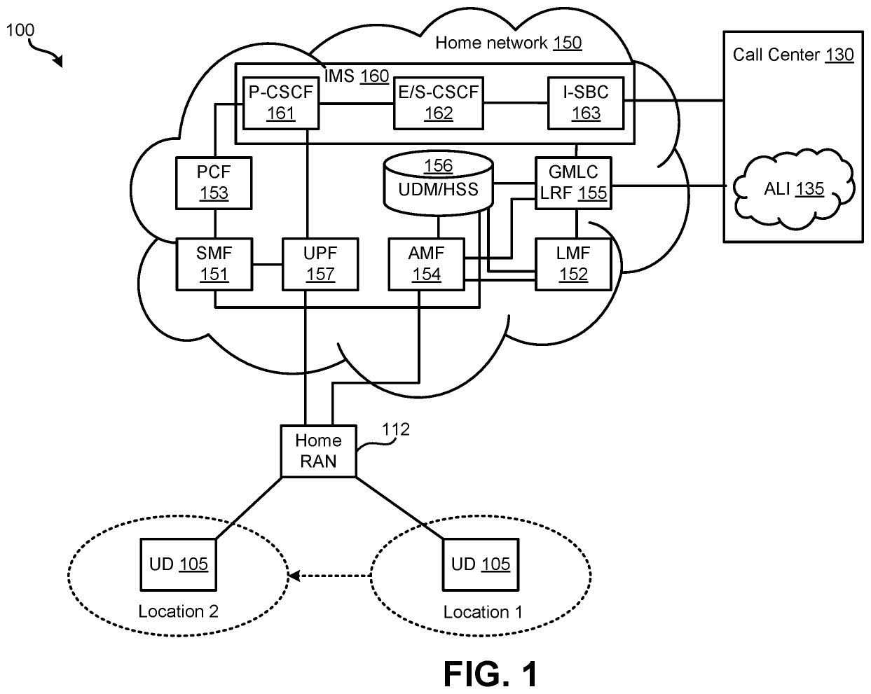

FIG. 1 is a schematic block diagram illustrating a communication system 100 for communicating the location information regarding a UD to a call center. The communication system 100 includes a UD 105 and components of a 5G network comprising a Radio Access Network (RAN) 112, which includes base stations (BSs) sometimes referred to as New Radio (NR) NodeBs or gNBs (collectively and generically referred to herein as gNBs), a home network 150 that is subscribed to by the UD 105 or provides network service to the UD 105, a call center 130 in communication with the home network 150.

The home network 150 further includes a Session Management Function (SMF) 151, a Location Management Function (LMF) 152, a Policy Control Function (PCF) 153, an Access and Mobility Management Function (AMF) 154, a Gateway Mobile Location Center (GMLC) 155, a Unified Data Management (UDM) 156, a User Plane Function (UPF) 157, and an IP Multimedia Subsystem (IMS) 160 that includes a Proxy Call Session Control Function (P-CSCF) 161, a corresponding Serving CSCF (S-CSCF) and/or Emergency Call Session Control Function (E-CSCF) 162, and an Interconnect Session Border Controller (I-SBC) 163.

The home network 150 here may be a 5G network (also referred to as a New Radio (NR) network). The RAN 112 may be referred to as an NR RAN or a 5G RAN; and the home network 150 may be referred to as a Fifth Generation (5G) Core network (5GC). The communication system 100 may include additional or alternative components.

It should be noted that FIG. 1 provides only a generalized illustration of various components, any or all of which may be utilized as appropriate, and each of which may be duplicated or omitted as necessary. Specifically, although only one UD 105 is illustrated, it will be understood that many UDs (e.g., hundreds, thousands, millions, etc.) may utilize the communication system 100. The illustrated connections that connect the various components in the communication system 100 include data (medium) and signaling connections which may include additional (intermediary) components, direct or indirect physical and/or wireless connections, and/or additional networks. Furthermore, components may be rearranged, combined, separated, substituted, and/or omitted, depending on desired functionality. While FIG. 1 illustrates a 5G-based network, similar network implementations and configurations may be used for other communication technologies, such as 3G, Long Term Evolution (LTE), 802.11 WiFi, etc.

The UD 105, as used herein, may be any electronic device and may be referred to as a user equipment (UE), a device, a mobile device, a wireless device, a mobile terminal, a terminal, a mobile station (MS), a Secure User Plane Location (SUPL) Enabled Terminal (SET), or by some other name. Moreover, UD 105 may correspond to a smart watch, digital glasses, fitness monitor, smart car, smart appliance, cellphone, smartphone, laptop, tablet, PDA, tracking device, control device or some other portable or moveable device. The UD 105 may include a single entity or may include multiple entities such as in a personal area network where a user may employ audio, video and/or data I/O devices and/or body sensors and a separate wireline or wireless modem. Typically, though not necessarily, the UD 105 may support wireless communication using one or more Radio Access Technologies (RATs) such as 5G new radio (NR) (e.g., using the RAN 112 and home network 150), etc. The UD 105 may also support wireless communication using a Wireless Local Area Network (WLAN) which may connect to other networks (e.g., the Internet) using a Digital Subscriber Line (DSL) or packet cable for example. The UD 105 may communicate with the call center 130 (e.g., via various elements of the home network 150 and/or possibly via a Gateway Mobile Location Center (GMLC) 155) and allow the call center 130 to receive location information regarding the UD 105.

The UD 105 may enter a connected state with a wireless communication network that may include the RAN 112. In one example, the UD 105 may communicate with a cellular communication network by transmitting wireless signals to, or receiving wireless signals from a cellular transceiver, in the RAN 112, such as a gNB included therein. A transceiver provides user and control planes protocol terminations toward the UD 105 and may be referred to as a base station, a base transceiver station, a radio base station, a radio transceiver, a radio network controller, a transceiver function, a base station subsystem (BSS), an extended service set (ESS), or by some other suitable terminology.

The UD 105 may have circuitry and processing resources capable of obtaining location related measurements. Location related measurements obtained by UD 105 may include measurements of signals received from satellites belonging to an Satellite Positioning System (SPS) or Global Navigation Satellite System (GNSS) and/or may include measurements of signals received from terrestrial transmitters fixed at known locations (e.g., such as gNBs included in the RAN 112). UD 105 or a separate location server (e.g., LMF 152), to which UD 105 may send the measurements, may then obtain a location data for the UD 105 based on these location related measurements. A UD 105 may transfer the location data and the location measurements to a location server, such as LMF 152, to determine a location for UD 105.

The gNBs included in the RAN 112 can communicate with the AMF 154, which, for positioning functionality, communicates with the LMF 152. The AMF 154 may support mobility of the UD 105, including cell change and handover and may participate in supporting a signaling connection to the UD 105 and possibly helping establish and release Protocol Data Unit (PDU) sessions for UD 105. Other functions of AMF 154 may include: termination of a control plane (CP) interface from RAN 112; termination of Non-Access Stratum (NAS) signaling connections from UDs such as UD 105, NAS ciphering and integrity protection; registration management; connection management; reachability management; mobility management; access authentication and authorization.

The SMF 151 connects to the AMF 154 and the UPF 157. The SMF 151 may have the capability to control a local and/or a central UPF within a PDU session. The SMF 141 may manage the establishment, modification and release of PDU sessions for UD 105, perform IP address allocation and management for UD 105, act as a Dynamic Host Configuration Protocol (DHCP) server for UE, and select and control a UPF on behalf of UD 105.

The UPF 157 may support voice and data bearers for UD 105 and may enable UD voice and data access to other networks such as the Internet. The UPF 157 may be connected to gNBs included in the RAN 112. UPF functions may include: external PDU session point of interconnect to a Data Network, packet (e.g. Internet Protocol (IP)) routing and forwarding, packet inspection and user plane part of policy rule enforcement, Quality of Service (QOS) handling for user plane, downlink packet buffering and downlink data notification triggering. UPF may be connected to a Secure User Plane Location (SUPL) Location Platform (SLP) to enable support of positioning of UD 105 using SUPL.

The PCF 153 uses the policy subscription information stored in the User Data Repository (UDR) to provide policy rules to network functions (e.g., SMF 151 and AMF 154). The PCF may use a standard interface to integrate with the AMF 154 for access and mobility policy, and with SMF 151 for session management policy.

The LMF 152 may support positioning of the UD 105 when UD 105 accesses the RAN 112 and may support position procedures/methods to obtain the accurate location/position information regarding the location/position of the UD 105. The LMF 152 may also process location services requests for the UD 105, e.g., received from the GMLC 155. In some embodiments, a node/system that implements the LMF 152 may additionally or alternatively implement other types of location-support modules, such as an Enhanced Serving Mobile Location Center (E-SMLC), a Secure User Plane Location (SUPL), or a Secure Location Platform (SLP). It will be noted that in some embodiments, at least part of the positioning functionality (including derivation of UD 105's location) may be performed at the UD 105 (e.g., using signal measurements for signals transmitted by wireless nodes, and assistance data provided to the UD 105). The LMF 152 may be referred to by other names such as a Location Manager (LM), Location Function (LF), commercial LMF (CLMF) or valUD added LMF (VLMF).

The GMLC 155 may support a location service request for the UD 105 received from the call center 130 and may forward such a location service request to the LMF 152. A location response from the LMF 152 (e.g., containing the location information for the UD 105) may be similarly returned to the GMLC 155 and the GMLC 155 may then return the location response (e.g., containing the location formation) to the call center 130. GMLC 155 may further initiate a location session for UD 105 by sending a location service request for UD 105 to LMF 152 and may include in the location service request an identity for UD 105 and the type of location being requested (e.g., such as a current location or a sequence of periodic or triggered locations). In contrast to a traditional CP location protocol, where a GMLC 155 may send a location service request for UD 105 to a serving AMF for UD 105 (e.g., AMF 154), GMLC 155 may only send a location service request for UD 105 to an LMF such as LMF 152. This may reduce impacts to AMFs (e.g., AMF 154) and may enable more efficient location of UD 105 as described below.

The GMLC 155 may be connected to a Location Retrieval Function (LRF), which may obtain the location of the UD 105 through interaction with UD 105, the gNB(s) included in the RAN 112, and/or computes the geolocation using suitable positioning methods such as signal triangulation techniques. The LRF may directly send the location information to the call center 130 or pass the location information to the IMS 160 for routing to the call center 130.

As further illustrated in FIG. 1, the LMF 152 and the RAN 112 may communicate using an appropriate position protocol (e.g., a New Radio Position Protocol A defined in 3GPP Technical Specification (TS) 36.455), with messages being transferred between the RAN and the LMF 152 via the AMF 154. The position protocol may be used to support positioning of UD 105 using UD assisted and/or UD based position methods. For example, the position protocol may be used to support positioning of UD 105 using network-based position methods such as Enhanced Call ID (ECID), when used with measurements obtained by a gNB included in the RAN 112. In some embodiments, the position protocol may be used by LMF 152 to obtain location related information from multiple gNBs included in the RAN 112 such as parameters defining positioning reference signal (PRS) transmission.

As illustrated in FIG. 1, the UDM 156 may be connected to the GMLC 155. The UDM 156 is analogous to a Home Subscriber Server (HSS) for LTE access, and if desired, the UDM 156 may be combined with an HSS. The UDM 156 is a central database that contains user-related and subscription-related information for UD 105 and may perform the following functions: UD authentication, UD identification, access authorization, registration and mobility management, subscription management and Short Message Service management. Additionally, the GMLC 155 may be connected to the LRF, which handles retrieval of location information for the UD 105 and may be used to provide location information for UD 105 to the call center 130 following an emergency call from UD 105 to the call center 130.

The IMS 160 is connected to the PCF 153, the UPF 157, and the call center 130. The IMS 160 may be used for establishing and releasing voice calls, data sessions and/or emergency calls which may be originated by or terminated to UD 105 using the IETF Session Initiation Protocol (SIP). As mentioned above, the IMS 160 may include a P-CSCF 161, an S-CSCF 162, a corresponding S-CSCF and/or E-CSCF 162, and an I-SBC 163, which are possibly as described in 3GPP TSs 23.228.

The P-CSCF 161 can represent functionality of a proxy server that receives data from the UD 105. The P-CSCF 161 may route incoming SIP messages of incoming voice calls from the UD 105 to S-CSCF/E-CSCF 162. The P-CSCF 161 may handle Internet Protocol Security (IPSec) for communications that are exchanged by the wireless user devices. The P-CSCF 161 may also handle Remote Authentication Dial-In User Service (RADIUS) sessions. The corresponding S-CSCF 162 may communicate with a telephony application server (TAS) that resides in the home network 150. The TAS may route voice and/or data communications within the home network 150 and with other networks, including public switch telephone networks (PSTNs). The E-CSCF 162 can implement functionality to configure the message for sending between the call center 130 and the IMS 160 for delivery to the emergency service center. The E-CSCF 162 may send a request to the call center 130, send a location query to the GMLC 155, and/or send a request for a protocol conversion to the call center 130 (or a third-party partner that provides protocol conversion services/values). The E-CSCF 162 may also receive location data and/or protocol data (e.g., a protocol, a protocol conversion value, etc.) from the GMLC 155.

The I-SBC 163 may serve as a connection point between the IMS 160 and the call center 130. The I-SBC 163 may provide SIP normalization and Topology Hiding and Internetwork Gateway (THIG) services. In some embodiments, the I-SBC 163 include transcoding unit(s) configured to performing transcoding of the media stream when different codecs are in use. The I-SBC 163 may also provide protocol normalization and header manipulation, enabling communication between different networks.

The call center 130 may be a service provider that operates in response to the emergency call. Examples of the call center includes but are not limited to: a PSAP capable of receiving and processing emergency calls from all voice communications service providers, a security service provider such as OnStar or ADT, a service monitoring agency, a senior care provider, and so on. In some embodiments, the call center 130 includes a location database. The location database may be an Automatic Location Identification (ALI) database 135. For example, the ALI database 135 may be connected to the PSAP included in the call center 130. The ALI database 135 is a secure database that contains the exact emergency address for given associated phone numbers. This database is queried by the PSAP at the time of an emergency call to obtain the caller's location. For example, if a caller dials an emergency phone number, then the ALI database 135 will be able to provide first responders with a location instantly in order to cut down on response time. By allowing phone numbers and/or the location information transmitted from the GMLC 155 to be saved in the ALI database 135, emergency situations are allowed to be addressed faster and with more accuracy.

As mentioned above, UD 105 may be able to initiate voice, text, video, or other data emergency calls. The IMS 160 can deliver these voice, text, video, and data emergency calls to the call center 130, which may be, for example, an emergency call center. The signaling protocol used for delivering these emergency calls may be the Session Initiation Protocol (SIP) defined by the Internet Engineering Task Force (IETF). In operation, the UD 105 may initiate an emergency call request. The emergency call request is for establishing an emergency call with an appropriate call center 130, and for delivery of location information associated with the UD 105 to the call center 130. The location information may be acquired via one or more procedures described above. The UD 105 may send a SIP message with an emergency indication to the UPF 157, and the SIP message may be further routed to the IMS 160 and received by the P-CSCF 161. The SIP message may include, among other information, a SIP header that conveys information carried by the SIP message.

The information carried by the SIP message may include location information regarding a current location of the UD 105 at the time the SIP message is sent to the home network 150. The current location of the UD 105 may be obtained by various methods described above (i.e., SPS, GNSS, or GPS). In some embodiments, the location information may also include static information and dynamic location information about the UD 105. The static location information may include the longitudinal and latitudinal coordinates of the UD 105, positional data (i.e., x, y, z coordinates) of the UD 105, relevant position of the UD 105 to a reference location (e.g., a nearby landmark, building, street, cross-road, etc.). The dynamic location information may include the moving speed of the UD 105, the moving direction of the UD 105, the route of the UD 105, the predicted position of the UD 105 at a future time point estimated by the speed, moving direction, and/or the route of the UD 105, and so on. A combination of the static location information and the dynamic location information may provide accurate location of the UD to the call center in a timely manner. The information carried by the SIP message may further include other emergency-related information such as timing, UD identification, caller identity associated with the UD 105, UD subscription information, caller account information, and so on.

In some embodiments, the UD 105 is configured to periodically send SIP messages to the home network 150 once an emergency call is initiated. Each SIP message contains location information regarding the current location of the UD 105 at the time the SIP message is sent to the home network. In this way, the call center may receive a timely update of the location information regarding the UD 105. In some embodiments, the UD 105 may be configured to periodically send a SIP message at a frequency. For example, the frequency may be once per 30 milliseconds; however, lower or higher frequencies are also possible in alternative embodiments.

The UD 105 may initiate an emergency call at a first location (i.e., Location 1), which may be routed to the call center 130 by the home network 150 through one of more gNBs included in the RAN 112. As discussed above, the signaling protocol and signaling path used for the routing information of Location 1 may be based on a SIP signaling, which includes receiving and sending SIP messages through the UPF 157, and IMS 160, and possible other elements in the home network 150. At some later time, UD 105 may move from the first location to a second location (i.e., Location 2). At the second location, the wireless signal coverage and strength may not change as compared with the first location (i.e., both Location 1 and Location 2 are within the coverage of the RAN 112). The emergency call initiated by the UD 105 at the first location may continue without undergoing a roaming process. The UD 105 may send SIP messages containing information regarding Location 2 to the home network 150, without changing the signaling protocol and path.

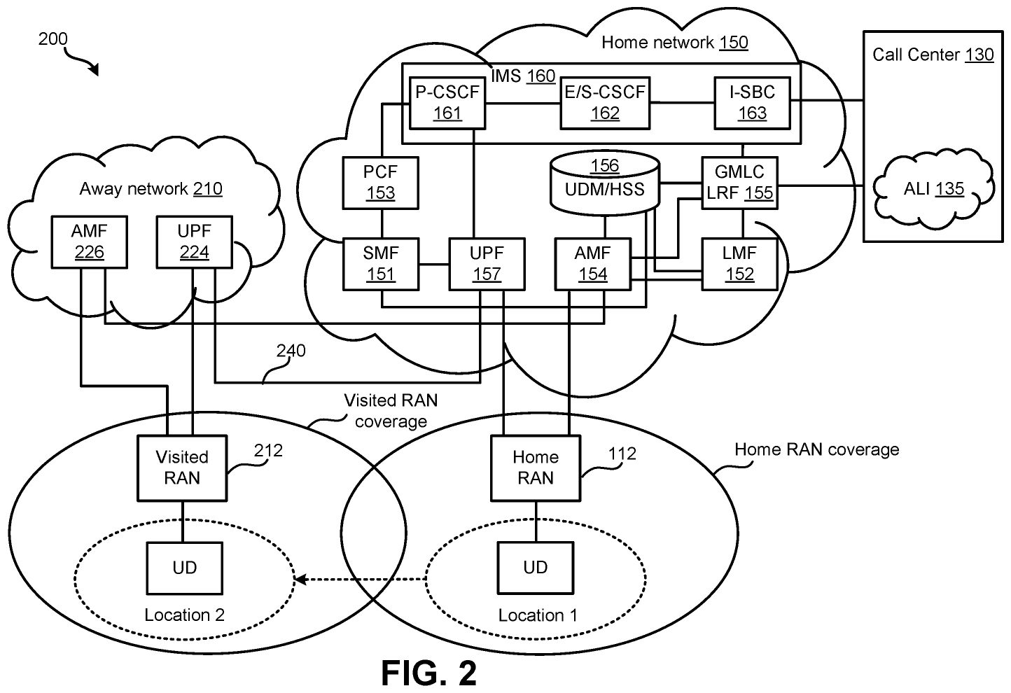

FIG. 2 is a schematic block diagram illustrating a communication system 200 for communicating location information regarding a UD that is roaming out of a home network to a call center. In the illustrated example, the communication system 200 includes a first network and a second network different from the first network. The first network may be the home network 150 (shown in FIG. 1), which is subscribed to by or provides service to the UD 105. The second network may be an away network 210 different from the home network and not subscribed to by the UD 105. The home network 150 is in communication with the home RAN 112, and the away network 210 is in communication with the away RAN 212. Like the home network 150, the away network 210 may be a 5G network. The away RAN 212 may also be a 5G RAN; and the away network 210 may also have a Fifth Generation (5G) Core network (5GC). The away network 210 includes, among other components, a UPF 224 and an AMF 226. The away network 210 may include additional components not shown in FIG. 2.

The UD 105 may move from a first location (i.e., Location 1) to a second location (i.e., Location 2). The first location is within the cellular coverage of the home network coverage (i.e., the coverage under the home RAN 112), and the second location is within the cellular coverage of the away network coverage (i.e., the coverage under the away RAN 212). The cellular coverage of the home RAN 112 may be sufficient at the first location but very weak at the second location. It is noted that the home network 150 and the away network 210 may be associated with different call centers. The UD 105 may move to the second location after an emergency call by a caller from the UD 105 has been initiated at the first location and connected to the call center 130 associated with the home network 150. In this scenario, the emergency call may roam out of the home network coverage and into the away network coverage. Because the away network 210 may be associated with a call center that is different from the original call center (i.e., the call center 130), the emergency call may be roamed out to the call center that is not associated with the home network 150, which may cause problems.

To keep the emergency call with the original call center (i.e., call center 130) once the UD 105 moves out of the coverage of the home RAN 112, the UD 105 may establish a connection with the away network 210 through the away RAN 212. In some embodiments, a signaling path between the UD 105 at the second location and the call center 130 associated with the home network 150 may be established by a user plane connection 240 that links the UPF 214 of the away network 210 and the UPF 157 of the home network 150. In this way, the location information regarding the UD 105 (e.g., included in SIP messages) sent from the UD 105 at the second location may still be received by the home network 150 and forwarded to the original call center (i.e., the call center 130) associated with the home network 150.

### Example Methods

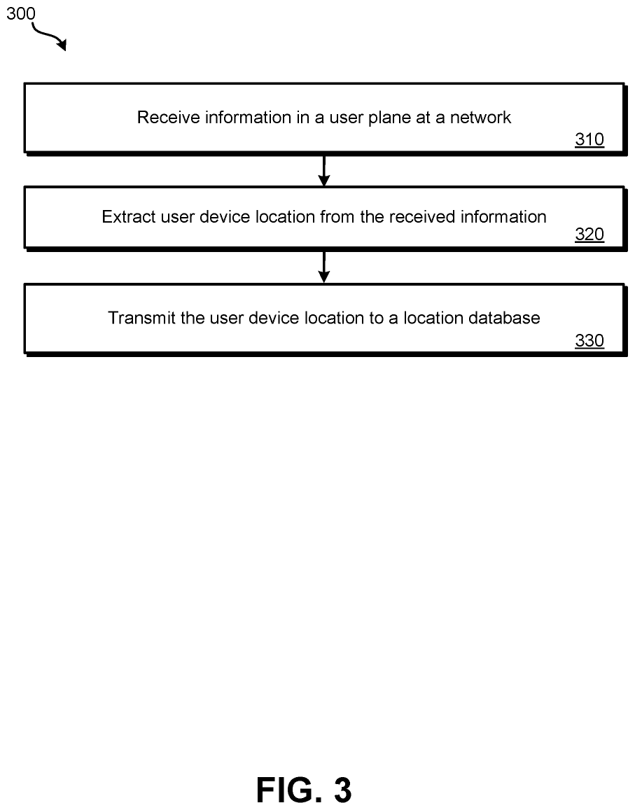

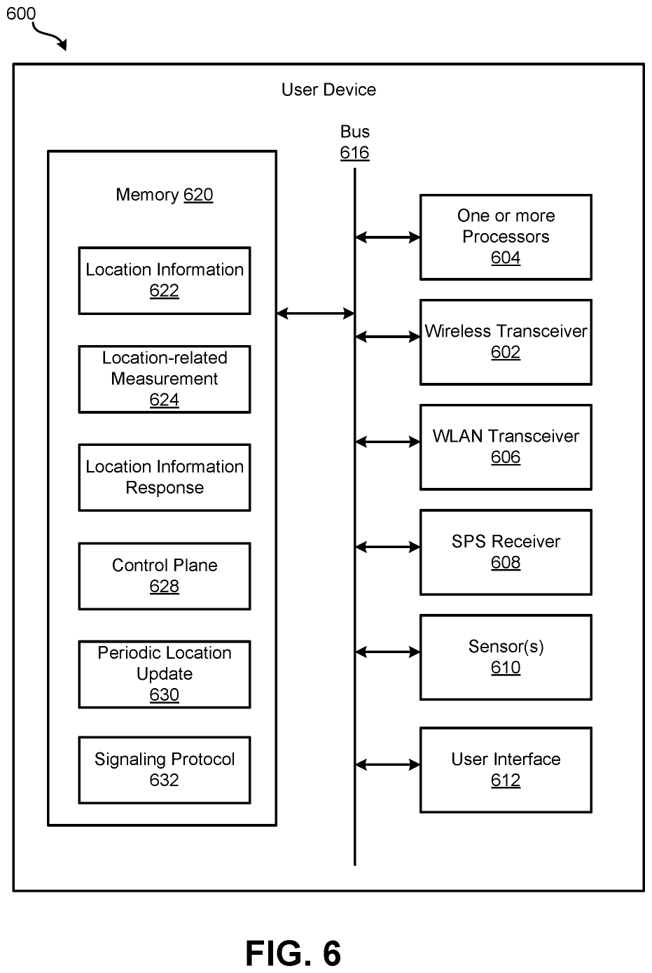

FIG. 3 is a flow diagram illustrating an example method 300 for facilitating a communication with a call center, according to various embodiments. The method may be implemented by a communication system described herein. It can be noted that, as with figures appended hereto, FIG. 3 is provided as a non-limiting example. Other embodiments may vary, depending on desired functionality. Means for performing the functionality of method 300 may include hardware and/or software means of a computer device or computer system, such any of devices described in FIG. 6.

At 310, information regarding a UD is received in a user plane function at a network (i.e., a home network). The network may be a 5G-based cellular network that is subscribed to by the UD or provides services to the UD. Once an emergency call has been initiated by the UD at a location within the coverage of the network, information regarding the UD is generated by the UD and is sent to the network through an RAN in communication with the network. The information regarding the UD may include emergency-related information, timing information, UD manufacture information, UD identification, caller identity associated with the UD, UD subscription information, caller account information, and so on.

The emergency-related information may include, among other things, location information indicating a current location of the UD at the time the information is generated. The current location of the UD may be obtained by various methods. In some embodiments, the current location may be generated by the UD. For example, location related measurements of signals may be received (e.g., from satellites, transmitters of the RAN, etc.) and processed by the UD to generate the current location of the UD. In some embodiments, the current location may be generated by a location server (e.g., the LMF, GMLC/LRF) of the network. For example, a location service request as well as the location related measurement may be transmitted from the UD to the LMF of the network, possibly through other network components such as AFM of the network. In response to the location request, the location related measurements may be processed by the LMF to obtain the accurate and precise location information of the current location of the UD. In some embodiments, an internal or external database may be accessed to assist in processing the location related measurements and generating the current location. As mentioned above, the location information may include static information and/or dynamic location information.

At 320, the received information is extracted to obtain the location information of the UD. In some embodiments, the information is received at the network in at least one packet of a signaling protocol. The signaling protocol may be a SIP, and the at least one packet may be a SIP header, a SIP UPDATE, or a SIP OPTIONS that are included in a SIP message sent from the UD. The SIP message received at the network may be processed and analyzed by the I-SBC to extract the emergency-related information and location information regarding the UD.

At 330, the location information regarding the UD is transmitted to a location database associated or in communication with a call center. The location database may be an ALI database described above. In some embodiments, the location information extracted from the information carried by the SIP message is transmitted to the GMLC and then routed to the location database through communication between the GMLC and the location database. As mentioned above, the local database may be a secure database that contains the exact address for the phone number associated with the UD. This location database may be queried by the call center at the time of an emergency call to obtain the caller's location. In some embodiments, the location information regarding the UD is temporarily stored in the location database, from which the location information can be accessed and retrieved by the call center.

In some embodiments, the UD is moving after an emergency call has been initiated at a first location. Multiple SIP messages may be sent to the network by the UD periodically at a frequency (e.g., on SIP message per 30 milliseconds). Each SIP message includes at least one packet that includes information related to the current/updated location of the UD when the SIP message is sent to the network and subsequently routed to the call center. In this way, the location of the UD can be closely monitored by the call center. In some embodiments, the UD is within the coverage of the home network when moving, and no handover of the emergency call occurs.

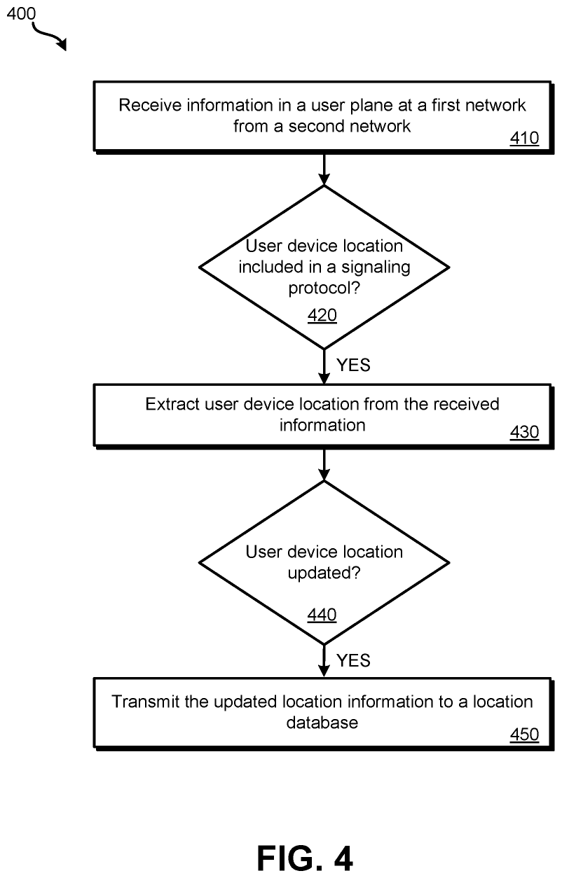

FIG. 4 is a flow diagram illustrating an example method 400 for facilitating inter-network handover of a communication with a call center, according to various embodiments. At 410, information regarding a UD is received in a user plane function at a first network from a second network. The first network may be a home network that is subscribed to by the UD or provides services to the UD. The second network may be an away network that is not subscribed to by the UD. The first network is associated with a local call center that is designated to the first network for receiving emergency calls initiated in the coverage of the first network. An emergency call may have been initiated by the UD at a first location within the coverage of the first network. The UD may have moved to a second location within the coverage of the second network, but out of the coverage of the first network. The emergency call may have roamed out of the first network into the second network.

In some embodiments, an inter-network signaling transmission path may be established between a first UPF of the first network and a second UPF of the second network for the signaling sent from the UD to transfer from the second UPF to the first UPF. This is particularly helpful for user plane location-based UDs. Even if the control plane of the second network is disconnected from the call center associated with the first network, the user plane connection (e.g., the user plane connection 240 of FIG. 2) between the first and second network may enable the signaling transmission from the UD to the call center associated with the first network. In this way, the current location information regarding the UD can be received by the call center associated with the first network even if the emergency call has been handed over to the second network and is roaming.

At 420, a determination is made on whether the location information is included in a signaling protocol. As mentioned above, the signaling protocol may be a SIP. A SIP message may be sent by the UD to the second network, routed to the first network through a user plane connection, and received by the first UPF of the first network.

At 430, in response to the determination that the signaling protocol is a SIP and that the SIP message received by the first network includes location information of the UD, the location information is extracted by a network function of the first network (e.g., the IMS) from the SIP message. In some embodiments, the location information includes a location service request and location-related measurements. The location service request and the location-related measurements may be transmitted to the LMF. In response to the location service request, the location-related measurements may be processed by the LMF to generate the current location/position of the UD accessible by the call center.

At 440, a determination is made on the presence or absence of a location change of the UD. In some embodiments, a first location of the UD is included in a first SIP message sent from the UD, and a second location of the UD is included in a second SIP message sent from the UD at the second location. The first location and the second location are compared (e.g., by a network function of the first network), and a determination is made on whether the second location is different from the first location. For example, a first location of the UD is received at the first network. The first location of the UD is included in the first SIP message and may be saved as the last-known location of the UD (e.g., when the emergency call was initiated at the first location within the coverage of the first network). A second location of the UD is received at the first network. The second location of the UD may be included in the second SIP message sent from the UD at the second location within the coverage of the second network. The first location is compared with the second location, and the second location is determined to be different from the first location.

In some embodiments, the UD of certain type (e.g., Apple iPhone) may use CP base positioning, and the SIP UPDATE or SIP OPTIONS messages along with location header are created and transmitted periodically, so the home network could receive another source of UD location, in an emergency call even when the UD is in the home network.

In some embodiments, when the UD is out of the home network (i.e., the first network for the UD) and moves across multiple away networks, SIP messages may be sent from the UD and received by the first network through one or more user plane connections interconnecting the multiple away networks and the home network. The multiple SIP messages may be sent by the UD periodically. The current location of the UD extracted from each SIP message received by the first network is compared with the last-known location of the UD extracted from the preceding SIP message to determine the presence or absence of a location change or update of the UD.

In some embodiments, the location of the UD extracted from the preceding SIP message is saved as the last-known location of the UD. Every SIP message received subsequent to the preceding SIP message by the first network is compared with the last-known location to determine the presence or absence of a location change or update. This allows continuous monitoring of the location of the UD after an emergency call has been initiated from the UD.

At 450, when the second location is determined to be different from the first location at 440, the updated location (i.e., the second location) of the UD may be transmitted to the location center. In some embodiments, the updated location is transmitted to the GMLC and then routed to the location database through communication between the GMLC and the location database. If no location change of the UD is determined, the second location information will not be transmitted to the location database. In this way, flooding the location database with the same location information of the UD could be effectively prevented.

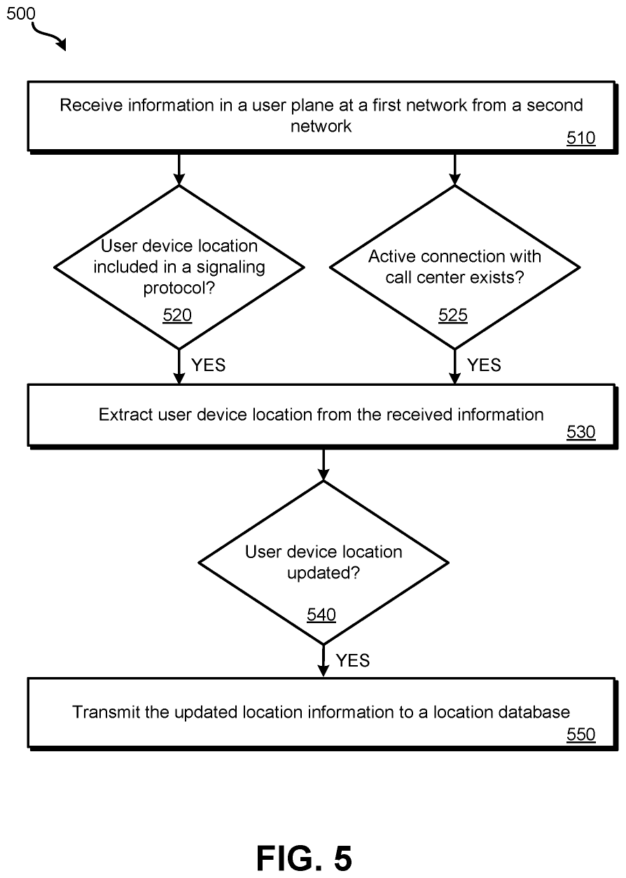

FIG. 5 is a flow diagram illustrating an example method 500 for facilitating inter-network handover of a communication with a call center, according to various embodiments. The method 500 is a close variation of the method 400. The steps/operations 510, 520, 530, 540, and 550 are respectively similar to the steps/operations 410, 420, 430, 440, and 450, and will not be repeated.

At 520, a determination on the presence or absence of an active connection between the UD and the call center is made. In some embodiments, the active connection includes a user plane connection between a first UPF of the first network and a second UPF of the second network. The user plane connection provides a signaling path for the UD to transmit SIP messages from the UD to the first network through the second network. The active connection between the UD and the caller center may also include the signaling path within the first network (i.e., the signaling path through the UPF, AMF, SMF, PCF, UDM/HSS, and IMS shown in FIG. 1). The presence or absence of the active connection between the UD and the call center may be detected and monitored by an inter-network device, the UPF of the first network, and/or other network functions internal or external to the first network, or any combination thereof.

In response to the presence of an active connection between the UD and the call center, the location information may be extracted from the information received by the UPF and IMS at the first network. In some embodiments, extracting the location information may be performed only upon the presence of both a suitable SIP protocol (determined at 520) and the active connection (determined at 525).

FIG. 6 is a block diagram illustrating an example of a hardware implementation of a UD 600, which is a representation of the UD 105 shown in FIGS. 1-2. The UD 600 may include a wireless transceiver 602 to wirelessly communicate with a RAN 112, e.g., base stations such as gNB (shown in FIGS. 1-2). The UD 600 may also include additional transceivers, such as a wireless local area network (WLAN) transceiver 606, as well as an SPS receiver 608. The UD 600 may further include one or more sensors 610, such as cameras, accelerometers, gyroscopes, electronic compass, magnetometer, barometer, etc. The UD 600 may further include a user interface 612 that may include e.g., a display, a keypad or other input device, such as virtual keypad on the display, through which a user may interface with the UD 600. The UD 600 further includes one or more processors 604 and memory 620, which may be coupled together with bus 616. The one or more processors 604 and other components of the UD 600 may similarly be coupled together with bus 616, a separate bus, or may be directly connected together or coupled using a combination of the foregoing. The memory 620 may contain executable code or software instructions that when executed by the one or more processors 604 cause the one or more processors to operate as a special purpose computer programmed to perform the algorithms disclosed herein.

As illustrated in FIG. 6, the memory 620 may include one or more components or modules that may be implemented by the one or more processors 604 to perform the methodologies described herein. While the components or modules are illustrated as software in memory 620 that is executable by the one or more processors 604, it should be understood that the components or modules may be dedicated hardware either in the one or more processors 604 or off the processors. As illustrated, the memory 620 may include a location information unit 622 that enables the one or more processors 604 to receive via the wireless transceiver 602 and process a request for location information for the UD 600 transmitted by a location server (e.g., LMF 152 or GMLC 155 of FIGS. 1-2). The location server sends the request for location information to the UD 600 in response to receiving an indication of an emergency call for the UD 600, or a periodic location update request. The location information unit 622 may generate location information indicating the current location of the UD 600.

The memory 620 may include a location-related measurement unit 624 that causes the one or more processors 604 to obtain the requested location-related measurement. The memory 620 may additionally include a location information response unit 626 that causes the one or more processors 604 to send via the wireless transceiver 602 the requested location-related measurement to the location server. The location server may process the location-related measurement sent by the UD 600. The memory 620 may also include a control plane unit 628 that causes the one or more processors 604 to use control plane interfaces and control plane protocols to receive the location information request and to send the location-related measurement response.

The memory 620 may also include a periodic location update unit 630 that causes the one or more processors 604 to monitor and detect a location change of the UD 600. The periodic location update unit 630 when implemented by the one or more processors 604 configures the one or more processors 604 to periodically detect the current location of the UD and send the location-related measurements to the location server (e.g., the GMLC). When a change of location is detected, the location-related measurement unit 624 may cause the one or more processors 604 to obtain the location-related measurement and the location information response unit 626 causes the location information to be sent.

The UD 600 may also include a signaling protocol unit 632 configured to generate SIP messages and include the location information and/or information-related measurements in a packet of the SIP message. The signaling protocol unit 632 is further configured to cause the generated SIP messages to be sent to the network through a signaling path. The signaling protocol unit 632 may operate in conjunction with the periodic location update unit 630 to include the periodic location update in the SIP message and periodically transmit the SIP messages at a frequency to the network through an active signaling path. The frequency may be adjusted by the signaling protocol unit 632.

### Example Computer System

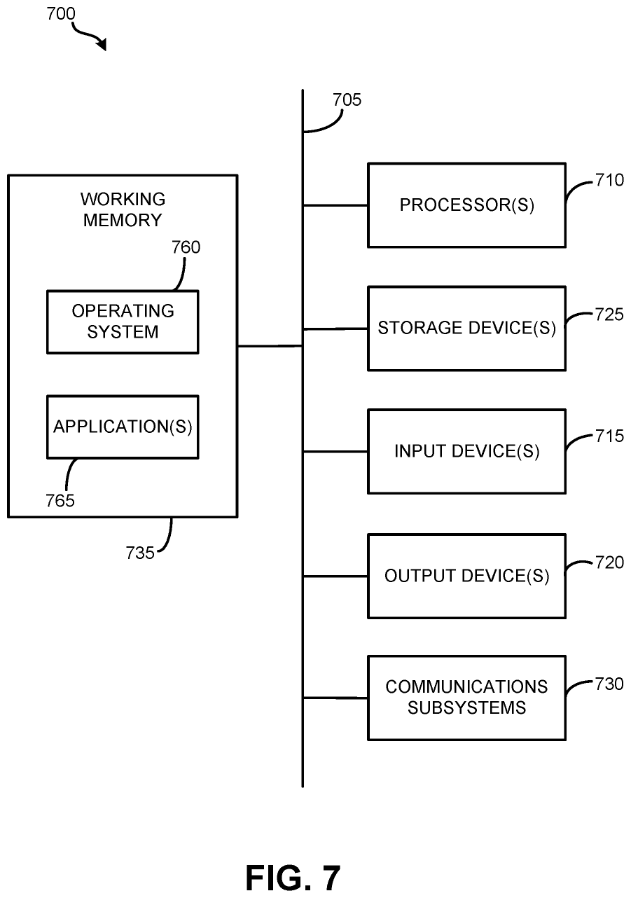

FIG. 7 is a schematic diagram illustrating an example of computer system 700. The computer system 700 is a simplified computer system that can be used to implement various embodiments described and illustrated herein. FIG. 7 provides a schematic illustration of one embodiment of a computer system 700 that can perform some or all of the steps of the methods and workflows provided by various embodiments. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer system 700 is shown including hardware elements that can be electrically coupled via a bus 705, or may otherwise be in communication, as appropriate. The hardware elements may include one or more processors 710, including without limitation one or more general-purpose processors and/or one or more special-purpose processors such as digital signal processing chips, graphics acceleration processors, and/or the like; one or more input devices 715, which can include without limitation a mouse, a keyboard, a camera, and/or the like; and one or more output devices 720, which can include without limitation a display device, a printer, and/or the like.

The computer system 700 may further include and/or be in communication with one or more non-transitory storage devices 725, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 700 might also include a communications subsystem 730, which can include without limitation a modem, a network card (wireless or wired), an infrared communication device, a wireless communication device, and/or a chipset such as a Bluetooth™ device, a 602.11 device, a WiFi device, a WiMax device, cellular communication facilities, etc., and/or the like. The communications subsystem 730 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 730. In other embodiments, a portable electronic device, e.g., the first electronic device, may be incorporated into the computer system 700, e.g., an electronic device as an input device 715. In some embodiments, the computer system 700 will further include a working memory 735, which can include a RAM or ROM device, as described above.

The computer system 700 also can include software elements, shown as being currently located within the working memory 735, including an operating system 760, device drivers, executable libraries, and/or other code, such as one or more application programs 765, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 7, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 725 described above. In some cases, the storage medium might be incorporated within a computer system, such as computer system 700. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 700 and/or might take the form of source and/or installable code, which, upon compilation and/or installation on the computer system 700 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 700 to perform methods in accordance with various embodiments of the technology. According to a set of embodiments, some or all of the operations of such methods are performed by the computer system 700 in response to processor 710 executing one or more sequences of one or more instructions, which might be incorporated into the operating system 760 and/or other code, such as an application program 765, contained in the working memory 735. Such instructions may be read into the working memory 735 from another computer-readable medium, such as one or more of the storage device(s) 725. Merely by way of example, execution of the sequences of instructions contained in the working memory 735 might cause the processor(s) 710 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 700, various computer-readable media might be involved in providing instructions/code to processor(s) 710 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 725. Volatile media include, without limitation, dynamic memory, such as the working memory 735.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700.

The communications subsystem 730 and/or components thereof generally will receive signals, and the bus 705 then might carry the signals and/or the data, instructions, etc. carried by the signals to the working memory 735, from which the processor(s) 710 retrieves and executes the instructions. The instructions received by the working memory 735 may optionally be stored on a non-transitory storage device 725 either before or after execution by the processor(s) 710.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for facilitating inter-network handover of a communication with a call center, the method being implemented by at least one electronic processor configured to execute computer programs, wherein the method comprises:
receiving, at a first network from a second network, information indicating a location of a user device;
detecting, at the first network, presence or absence of an active connection between the user device and the first network;
obtaining, at the first network, the location of the user device from the received information, in response to the presence of the active connection; and
transmitting the information indicating the location to a location database in communication to the call center.

2. The method of claim 1, wherein the information is received after an emergency call is initiated from the user device.

3. The method of claim 1, wherein the information received at the first network is included in at least one packet of a signaling protocol.

4. The method of claim 3, wherein the signaling protocol is a session initiation protocol (SIP), and the at least one packet is a SIP header.

5. The method of claim 1, wherein the information is received at the first network after the user device moves from the first network to the second network during the active connection with the call center.

6. The method of claim 1, further comprising:
obtaining, at the first network, last-known location of the user device; and
comparing, at the first network, the location of the user device received from the second network with the last-known location of the user device,
wherein the transmission of the location of the user device to the call center is performed after an outcome of the comparison indicates a difference between the location of the user device and the last-known location of the user device.

7. The method of claim 6, further comprising:
saving the user device location received from the second network as the last-known user device location.

8. The method of claim 1, wherein the information is received at the first network in a user plane.

9. The method of claim 8, wherein the information is received through a user plane connection between a first user plane function of the first network and a second user plane function of the second network.

10. The method of claim 1, wherein the information is received from the second network periodically.

11. A computer system for facilitating inter-network handover of a communication with a call center, the computer system comprising:
a processor; and
a computer-readable storage media storing computer-executable code that, when executed by the processor, causes the computer system to:
receive, at a first network from a second network, information indicating a location of a user device;
detect, at the first network, presence or absence of an active connection between the user device and the first network;
obtain, at the first network, the location of the user device from the received information, in response to the detection of the presence of the active connection; and
transmit the information indicating the location to a location database in communication to the call center.

12. The computer system of claim 11, wherein the information is received after an emergency call is initiated from the user device.

13. The computer system of claim 11, wherein the information received at the first network is included in at least one packet of a signaling protocol.

14. The computer system of claim 11, wherein the signaling protocol is a session initiation protocol (SIP), and the at least one packet is a SIP header.

15. The computer system of claim 11, wherein the information is received at the first network after the user device moves from the first network to the second network during the active connection with the call center.

16. The computer system of claim 11, wherein, when executed by the processor, the computer-executable code further causes the computer system to:
obtain, at the first network, last-known location of the user device; and
compare, at the first network, the location of the user device received from the second network with the last-known location of the user device,
wherein the transmission of the location of the user device to the call center is performed after an outcome of the comparison indicates a difference between the location of the user device and the last-known location of the user device.

17. The computer system of claim 16, wherein, when executed by the processor, the computer-executable code further causes the computer system to:
saving the user device location received from the second network as the last-known user device location.

18. A user device comprising:
a processor; and
a computer-readable storage media storing computer-executable code that, when executed by the processor, causes the user device to:
generate information of the user device in response to an emergency call initiated by the user device, the information indicating a current location of the user device;
generate a SIP message including the information indicating the current location of the user device;
determine presence or absence of an active connection between the user device and a first network, the first network being associated with a call center; and
in response to the presence of an active connection between the user device and a first network, transmit the SIP message to a first user plane function of the first network to allow the information included in the SIP message to be routed to the call center.

19. The user device of claim 18, when executed by the processor, the computer-executable code further causes the user device to:
determine whether the user device roams out into a second network;
in respond to the determination that the user device roams out to the second network, determine presence or absence of an active connection between the user device and the second network, the second network in user plane connection with the first network; and
transmit the SIP message to a second user plane function of the second network to allow the SIP message to be routed to the first network via the plane user connection.

20. The user device of claim 18, wherein, the SIP message is generated and transmitted to the user plane function periodically.
